(19) United States
(12) Patent Application Publication
(10) Pub. No.: US 2002/0183090 A1
(43) Pub. Date: Dec. 5, 2002

(54) Method for performing arithmetic operations and engineering based arithmetic operations in mobile phone

(76) Inventors: David Ho, Taipei Hsieng (TW); Tony Tsai, Taipei Hsieng (TW); Yu-Bin Chen, Taipei Hsieng (TW)

Correspondence Address: BACON & THOMAS, PLLC, 625 SLATERS LANE, FOURTH FLOOR, ALEXANDRIA, VA, 22314

(21) Appl. No.: 09/870,490

(22) Filed: Jun. 1, 2001

(51) Int. Cl. H04B 1/38

(52) U.S. Cl. 455/556; 455/550; 455/575; 455/90

(57) ABSTRACT

A process for performing arithmetic operations and engineering based arithmetic operations in a mobile phone comprises the steps of storing an arithmetic operation software and an engineering based arithmetic operation software in a memory of the mobile phone, selecting one of the software, showing an input interface on a display of the mobile phone in response to the selection, inputting operands and operator for performing a calculation thereon, and showing a result of the calculation on the display. Also, the arithmetic operation software comprises an input interface in response to a pressed button on a keypad of the mobile phone such that user may input operands and operator by pressing the corresponding buttons based on the location of the operator in the input interface.

### FIELD OF THE INVENTION

The present invention relates to mobile phones and more particularly to a method for performing arithmetic operations and engineering based arithmetic operations in mobile phone.

### BACKGROUND OF THE INVENTION

Mobile phones have become popular worldwide due to the advantages of being compact, portable, well featured, and inexpensive. People can communicate each other in a quick and simple way irrespective of the geographical locations. In view of above, mobile phones are advantageous over conventional cable telephones. In recent years, there is a trend of being slim and multi functional with respect to the design and development of mobile phones. Hence, a mobile phone having the features of other electronic products is gaining popularity among consumers. For example, a mobile phone may have additional features of arithmetic operations such as addition, subtraction, multiplication, and division. However, a mobile phone user has to carry an additional calculator capable of performing complex engineering based arithmetic operations if such operations are needed in the user's work. In view of above, it is quite inconvenient. Thus, it is desirable to provide a mobile phone which is capable of performing both arithmetic operations and engineering based arithmetic operations in order to overcome the above drawback of prior art.

### SUMMARY OF THE INVENTION

It is an object of the present invention to provide a process for performing arithmetic operations and engineering based arithmetic operations in a mobile phone comprising the steps of (a) storing an arithmetic operation software and an engineering based arithmetic operation software in a memory of the mobile phone; (b) selecting one of the arithmetic operation software and the engineering based arithmetic operation software; (c) showing an input interface on a display of the mobile phone in response to the selection; (d) inputting operands and operator for performing a calculation thereon; and (e) showing a result of the calculation on the display of the mobile phone.

In one aspect of the present invention there is an input interface provided by the arithmetic operation software in response to a pressed button on a keypad of the mobile phone such that a user may input operands and operator by pressing the corresponding buttons based on the location of the operator shown in the input interface, thereby effecting an arithmetic operation.

The above and other objects, features and advantages of the present invention will become apparent from the following detailed description taken with the accompanying drawings.

### BRIEF DESCRIPTION OF THE DRAWINGS

FIG. 1 is a flow chart illustrating the process for performing arithmetic operations and engineering based arithmetic operations in a mobile phone according to the invention;

FIG. 2 is a top plan view of a mobile phone capable of performing arithmetic operations and engineering based arithmetic operations according to the invention wherein a menu of engineering based arithmetic operation is shown in DEG;

FIG. 3 is a view similar to FIG. 2 wherein a menu of engineering based arithmetic operation is shown in RAD; and

FIG. 4 is a view similar to FIG. 2 wherein a menu of arithmetic operation is shown.

### DETAILED DESCRIPTION OF THE PREFERRED EMBODIMENTS

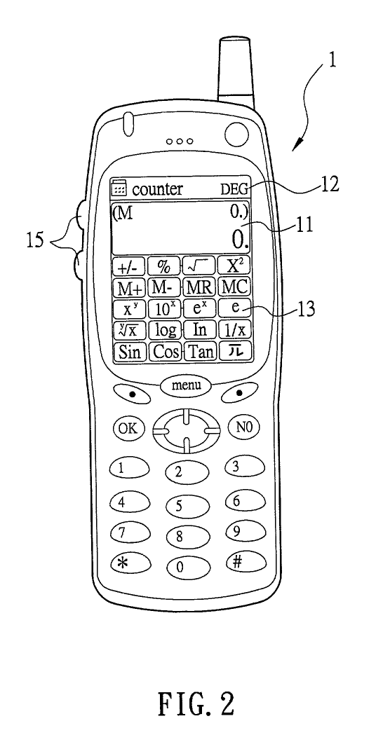

Referring to FIG. 2, there is shown a mobile phone 1 capable of performing arithmetic operations and engineering based arithmetic operations constructed in accordance with the invention. In the mobile phone 1, a process for performing arithmetic operations and engineering based arithmetic operations comprising the steps of (a) storing an arithmetic operation software and an engineering based arithmetic operations software in a memory of the mobile phone 1; (b) selecting one of the arithmetic operation software and the engineering based arithmetic operation software by a user; (c) showing an input interface on a display 11 of the mobile phone 1 in response to the selection; (d) inputting operands and operator for performing a calculation thereon; and (e) showing a result of the calculation on the display 11 of the mobile phone 1.

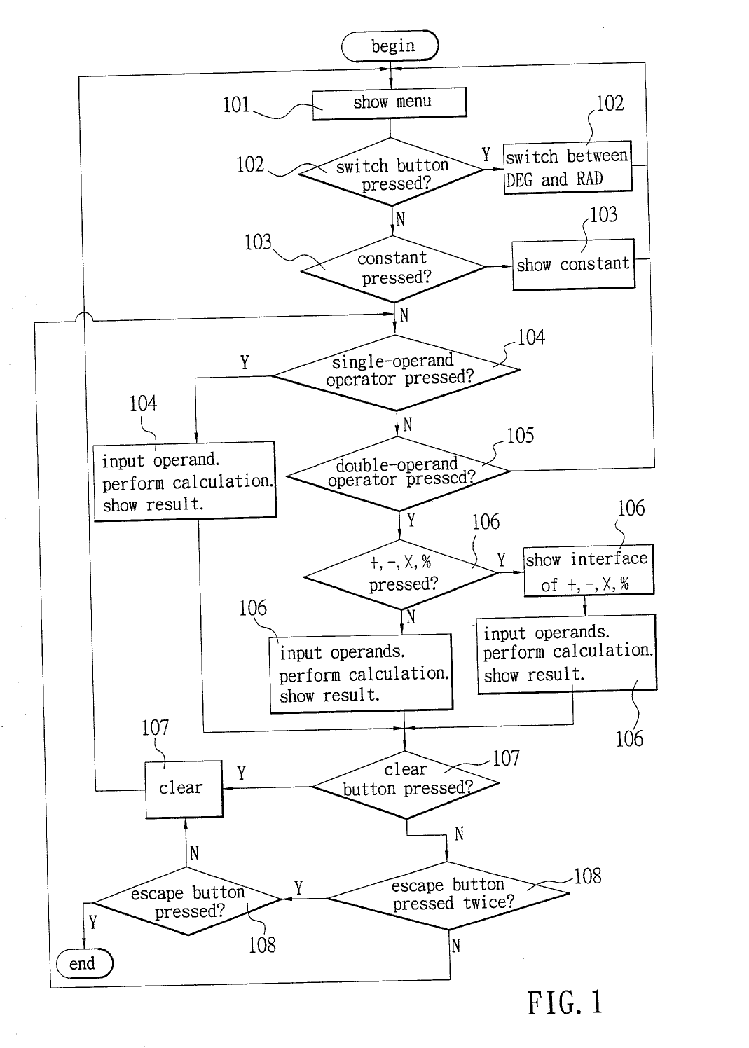

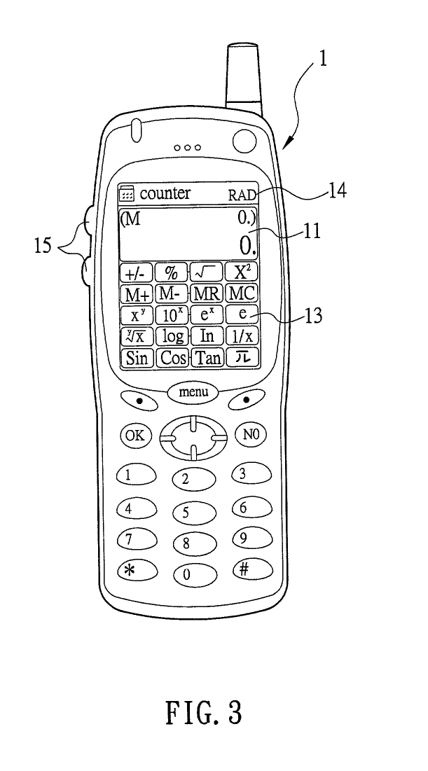

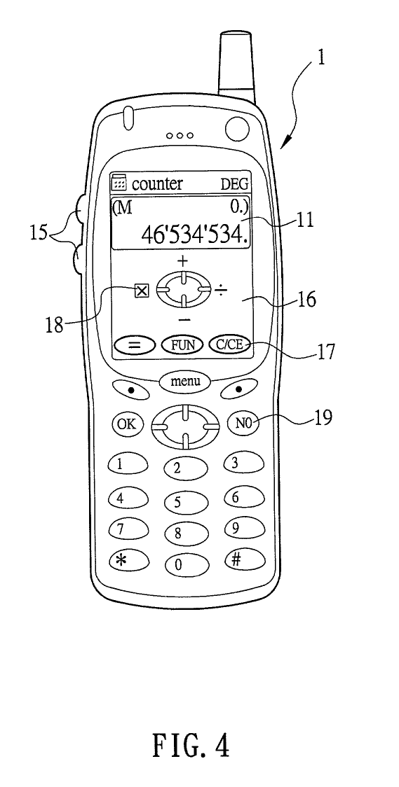

Referring to the accompanying drawings and particular to FIG. 1, when a calculation mode is selected, the process for performing arithmetic operations or engineering based arithmetic operations in a microprocessor of the mobile phone 1 is detailed below. As shown in FIG. 2, in step 101, read out arithmetic operation software and engineering based arithmetic operation software from the memory of mobile phone 1 and show a menu 13 of the arithmetic operation and engineering based arithmetic operation software on display 11 of mobile phone 1 (FIG. 2) for user's selection. In step 102, a determination is made whether a switch button 15 (e.g., volume) of mobile phone 1 is pressed. If not, the process goes to step 103. If yes, switch between setting an input unit of trigonometric function as degree (DEG) and setting an input unit of trigonometric function as radian (RAD) in the decimal system. For example, DEG 12 may be switched to RAD 14 or vice versa (see FIGS. 2 and 3). The process returns to step 101. In step 103, a determination is made whether one of a plurality of constants (e.g., Tr, e, etc.) has been selected by user by pressing a corresponding button on menu 13. If not, the process goes to step 104. If yes, show the same on display 11. The process returns to step 101. In step 104, a determination is made whether one of a plurality of single-operand operators (e.g., log, sin, etc.) has been selected by user by pressing a corresponding button on menu 13. If not, the process goes to step 105. If yes, perform a calculation on the inputted operand and the operator and show a result of the calculation on display 11. The process goes to step 107. In step 105, a determination is made whether one of a plurality of double-operand operators (e.g., +, −, ×, 34 , XY, etc.) is pressed. If such operator is pressed, the process goes to step 106. If not, the process returns to step 101. In step 106, a determination is made whether the selected operator is one of addition, subtraction, multiplication, and division. If yes, show an input interface 16 including the icons of addition, subtraction, multiplication, and division on display 11 (FIG. 4). If yes, user may input operands and operator by pressing the corresponding buttons on a keypad of the mobile phone 1 based on the location of the operator shown in the input interface 16. The inputted operator is highlighted 18 on display 11. Then a calculation is performed based on the inputted operands and operator. Finally, a result of the calculation is shown on display 11. The process goes to step 107. If not, a calculation is performed based on the inputted operands and operator. Finally, a result of the calculation is shown on display 11. The process also goes to step 107. In step 107, a determination is made whether a clear button (e.g., C/CE, etc. as shown in FIG. 4) 17 is pressed. If yes, clear the display 11 and the process returns to step 101. If not, the process goes to step 108. In step 108, a determination is made whether an escape button (e.g., NO, etc. as shown in FIG. 4) 19 is pressed. If not, the process goes to step 104. If yes, a further determination is made whether the escape button is pressed again. If yes, the process ends. If not, clear the display 11 and the process returns to step 101.

While the invention has been described by means of specific embodiments, numerous modifications and variations could be made thereto by those skilled in the art without departing from the scope and spirit of the invention set forth in the claims.

What is claimed is:

1. A process for performing arithmetic operations and engineering based arithmetic operations in a mobile phone comprising the steps of:
(a) storing one or more software in a memory of the mobile phone;
(b) selecting one of the software;
(c) reading an input interface from the memory of the mobile phone by a microprocessor of the mobile phone in response to the selection;
(d) showing the input interface on a display of the mobile phone;
(e) inputting operands and operator;
(f) performing a calculation on the inputted operands and operator by the microprocessor of the mobile phone; and
(e) showing a result of the calculation on the display of the mobile phone.

2. The process of claim 1, wherein the software is an arithmetic operation software.

3. The process of claim 2, wherein the arithmetic operation software comprises an input interface in response to a pressed button on a keypad of the mobile phone such that operands and operator are capable of inputting by pressing the corresponding buttons based on the location of the operator in the input interface.

4. The process of claim 1, wherein the software is an engineering based arithmetic operation software.

5. The process of claim 1, wherein after the step (c) of reading an input interface from the memory of the mobile phone by a microprocessor of the mobile phone in response to the selection, a menu of the selected software is shown on the display.

6. The process of claim 5, wherein when a switch button is determined to be pressed by the microprocessor, a switch between setting an input unit of trigonometric function as degree and setting an input unit of trigonometric function as radian in the decimal system is made.

7. The process of claim 5, wherein when one of a plurality of constants on the menu is determined to be selected by the microprocessor, the selected constant is shown on the display.

8. The process of claim 5, wherein when one of a plurality of single-operand operators on the menu is determined to be selected by the microprocessor, an input of an operand is made and a calculation on the operand and the operator is performed.

9. The process of claim 5, wherein when one of a plurality of double-operand operators on the menu is determined to be selected by the microprocessor, an input of operands is made and a calculation on the operands and the operator is performed.

10. The process of claim 9, wherein when the selected single-operand operator is determined to be one of addition, subtraction, multiplication, and division by the microprocessor, an input interface including the icons of addition, subtraction, multiplication, and division is shown on the display, an input of operands is made, and a calculation on the operands and the operator is performed.
